(19) United States
(12) Patent Application Publication
(10) Pub. No.: US 2012/0172519 A1
(43) Pub. Date: Jul. 5, 2012

(54) HYDROPHILIC POLYURETHANE UREA DISPERSIONS

(75) Inventors: Sebastian Dörr, Dusseldorf (DE); Jürgen Köcher, Langenfeld (DE); Jörg Hofmann, Krefeld (DE)

(73) Assignee: Bayer MaterialScience AG, Leverkusen (DE)

(21) Appl. No.: 13/394,561

(22) PCT Filed: Sep. 4, 2010
(86) PCT No.: PCT/EP2010/005441

§ 371 Date: Mar. 7, 2012

(30) Foreign Application Priority Data
Sep. 17, 2009 (EP) 09011853.0

(51) Int. Cl. C09D 175/04; C09D 175/08

(52) U.S. Cl. 524/590

(57) ABSTRACT

The invention relates to a polyurethane urea dispersion, wherein the polyurethane urea (1) is terminated with a copolymer unit of polyethylene oxide and poly-C4-C12-alkylene oxide, and (2) comprises at least one polycarbonate polyol containing hydroxyl groups.

The present invention relates to a coating composition in the form of a polyurethaneurea dispersion that can be used for producing hydrophilic coatings. Further subject matter of the present invention is a process for preparing such a coating composition, and the use of the coating composition, more particularly for the coating of medical devices.

The utilization of medical devices, such as of catheters, can be improved greatly through the equipping thereof with hydrophilic surfaces. The insertion and displacement of urinary or blood vessel catheters is made easier by the fact that hydrophilic surfaces in contact with blood or urine adsorb a water film. This reduces the friction between the catheter surface and the vessel walls, so making the catheter easier to insert and move. Direct watering of the devices prior to the intervention can also be carried out, in order to reduce the friction through the formation of a homogeneous water film. The patients concerned have less pain, and the risk of injury to the vessel walls is reduced as a result. Furthermore, when catheters are used in blood contact, there is always a risk of blood clots forming. In this context, hydrophilic coatings are generally regarded as helpful for antithrombogenic coatings.

Suitability for the production of such surfaces is possessed in principle by polyurethane coatings which are produced starting from solutions or dispersions of corresponding polyurethanes. Thus U.S. Pat. No. 5,589,563 describes the use of coatings having surface-modified end groups for polymers which are used in the biomedical sector and which can also be used for the coating of medical devices. The resulting coatings are produced on the basis of solutions or dispersions, and the polymeric coatings comprise different end groups, selected from amines, fluorinated alkanols, polydimethylsiloxanes and amine-terminated polyethylene oxides. These polymers, however, do not have satisfactory properties as a coating for medical devices, more particularly in respect of the required hydrophilicity.

DE 199 14 882 A1 relates to polyurethanes, polyurethaneureas and polyureas in dispersed or dissolved form that are synthesized from
(a) at least one polyol component,
(b) at least one di-, tri- and/or polyisocyanate component,
(c) at least one hydrophilic, nonionic or potentially ionic synthesis component, consisting of compounds having at least one group that is reactive towards isocyanate groups, and at least one hydrophilic polyether chain, and/or of compounds having at least one group that is capable of forming salts and if desired is present in at least partly neutralized form, and at least one group that is reactive towards isocyanate groups,
(d) at least one synthesis component, different from (a) to (c), of the molecular weight range 32 to 500, having at least one group that is reactive towards isocyanate groups, and
(e) at least one monofunctional blocking agent. The polymer dispersions, which thus necessarily have a monofunctional blocking agent, are used in sizes.

DE 199 14 885 A1 relates to dispersions based on polyurethanes, polyurethane-polyureas or polyureas, which preferably represent reaction products of
a) at least one polyol component,
b) at least one di-, tri- and/or polyisocyanate component,
c) if desired, at least one (potentially) ionic synthesis component, consisting of compounds having at least one group that is reactive towards NCO groups, and at least one group that is capable of forming salts and if desired is present in at least partly neutralized form,
d) if desired, at least one nonionically hydrophilic synthesis component, consisting of compounds having a functionality of one to four in the sense of the isocyanate addition reaction, and containing at least one hydrophilic polyether chain,
e) if desired, at least one synthesis component, different from (a) to (d), of the molecular weight range 32 to 2500, having groups that are reactive towards isocyanate groups, and
f) 0.1 to 15% by weight of at least one monofunctional blocking agent which is composed to an extent of at least 50% of dimethylpyrazole,
   the sum of a) to f) being 100%, and either c) or d) not being able to be 0 and being used in an amount such that a stable dispersion is formed. The dispersions are used, among other things, for coating mineral substrates, for varnishing and sealing wood and wood-based materials, for painting and coating metallic surfaces, for painting and coating plastics, and for coating textiles and leather.

These polyurethaneurea dispersions known from the prior art are not used for medical purposes, i.e. for coating medical devices.

Furthermore, the polyurethaneurea coatings known to date frequently have disadvantages in that they are not sufficiently hydrophilic for use as a coating on medical devices.

In this context, U.S. Pat. No. 5,589,563 recommends surface-modified end groups for biomedical polymers which can be used to coat medical devices. These polymers include different end groups, selected from amines, fluorinated alkanols, polydimethylsiloxanes and amine-terminated polyethylene oxides. As a coating for medical devices, however, these polymers likewise lack satisfactory properties, more particularly in respect of the required hydrophilicity.

It is an object of the present invention, therefore, to provide coating compositions which may be used for providing medical devices with hydrophilic surfaces. Since these surfaces are frequently used in blood contact, the surfaces of these materials ought also to possess good blood compatibility and ought more particularly to reduce the risk of blood clots being formed.

This invention provides coating compositions in the form of polyurethaneurea dispersions which may be used for providing medical devices with hydrophilic surfaces.

The coating compositions of the invention in the form of a dispersion are characterized in that they comprise
(1) at least one polyurethaneurea which is terminated with a copolymer unit comprising polyethylene oxide and poly-C₄-C₁₂-alkylene oxide, and
(2) at least one hydroxyl group-containing polycarbonate polyol.

In accordance with the invention it has been found that compositions comprising these specific polyurethaneureas are outstandingly suitable as coatings of medical devices, to which they give an outstanding lubricous coating and at the same time reduce the risk of blood clots forming during treatment with the medical device.

Polyurethaneureas for the purposes of the present invention are polymeric compounds which have
(a) repeat units containing at least two urethane groups, of the following general structure

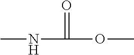

and
at least one repeat unit containing urea groups

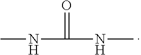

The coating compositions for use in accordance with the invention are based on polyurethaneureas which have substantially no ionic modification. By this is meant, in the context of the present invention, that the polyurethaneureas for use in accordance with the invention have essentially no ionic groups, such as, more particularly, no sulphonate, carboxylate, phosphate and phosphonate groups.

The term “essentially no ionic modification” means, in the context of the present invention, that ionic modification is present in a fraction of at most 2.50% by weight, preferably at most 2.00% by weight, more particularly at most 1.50% by weight, more preferably at most 1.00% by weight, especially at most 0.50% by weight, it being most preferred for the polyurethaneurea provided in accordance with the invention to have absolutely no ionic modification.

The polyurethaneureas are preferably substantially linear molecules, but may also be branched, although this is less preferred. By substantially linear molecules are meant systems with a low level of incipient crosslinking, comprising a polycarbonate polyol having an average hydroxyl functionality of preferably 1.7 to 2.3, more particularly 1.8 to 2.2, more preferably 1.9 to 2.1. Such systems may still be dispersed to a sufficient degree.

The number-average molecular weight of the polyurethaneureas used with preference in accordance with the invention is preferably 1000 to 200 000, more preferably from 5000 to 100 000. The number-average molecular weight here is measured against polystyrene as standard in dimethylactamide at 30° C.

### Polyurethaneureas

The polyurethaneureas are described in more detail below.

The polyurethaneureas may be prepared by reaction of synthesis components which encompass at least one polycarbonate polyol component, one polyisocyanate component, one polyoxyalkylene ether component, one diamine and/or amino alcohol component and, if desired, one polyol component.

The individual synthesis components are now described in more detail below.

### (a) Polycarbonate Polyol

The polyurethaneurea comprises units which originate from at least one hydroxyl-containing polycarbonate (polycarbonate polyol).

Suitable in principle for the introduction of units based on a hydroxyl-containing polycarbonate are polycarbonate polyols, i.e. polyhydroxyl compounds having an average hydroxyl functionality of 1.7 to 2.3, preferably of 1.8 to 2.2, more preferably of 1.9 to 2.1. Thus the polycarbonate is preferably of substantially linear construction and has only a slight three-dimensional crosslinking.

Suitable hydroxyl-containing polycarbonates are polycarbonates of the molecular weight (molecular weight determined by OH number; DIN 53240) of preferably 400 to 6000 g/mol, more preferably 500 to 5000 g/mol, more particularly of 600 to 3000 g/mol, which are obtainable, for example, through reaction of carbonic acid derivatives, such as diphenyl carbonate, dimethyl carbonate or phosgene, with polyols, preferably diols. Examples of suitable such diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, di-, tri- or tetraethylene glycol, dipropylene glycol, polypropylene glycols, dibutylene glycol, polybutylene glycols, bisphenol A, tetrabromobisphenol A, and also lactone-modified diols.

The diol component preferably contains 40% to 100% by weight of hexanediol, preferably 1,6-hexanediol and/or hexanediol derivatives, preferably those which as well as terminal OH groups contain ether or ester groups, examples being products obtained by reaction of 1 mol of hexanediol with at least 1 mol, preferably 1 to 2 mol, of caprolactone or through etherification of hexanediol with itself to give the di- or trihexylene glycol. Polyether-polycarbonate diols as well can be used. The hydroxyl polycarbonates ought to be substantially linear. If desired, however, they may be slightly branched as a result of the incorporation of polyfunctional components, more particularly low molecular weight polyols. Examples of those suitable for this purpose include glycerol, trimethylolpropane, hexane-1,2,6-triol, butane-1,2,4-triol, trimethylolpropane, pentaerythritol, quinitol, mannitol, sorbitol, methylglycoside or 1,3,4,6-dianhydrohexitols. Preferred polycarbonates are those based on hexane-1,6-diol, and also on co-diols with a modifying action such as butane-1,4-diol, for example, or else on ε-caprolactone. Further preferred polycarbonate diols are those based on mixtures of hexane-1,6-diol and butane-1,4-diol.

### (b) Polyisocyanate

The polyurethaneurea also has units which originate from at least one polyisocyanate.

As polyisocyanates (b) it is possible to use all of the aromatic, araliphatic, aliphatic and cycloaliphatic isocyanates that are known to the skilled person and have an average NCO functionality 1, preferably 2, individually or in any desired mixtures with one another, irrespective of whether they have been prepared by phosgene or phosgene-free processes. They may also contain iminooxadiazinedione, isocyanurate, uretdione, urethane, allophanate, biuret, urea, oxadiazinetrione, oxazolidinone, acylurea and/or carbodiimide structures. The polyisocyanates may be used individually or in any desired mixtures with one another.

Preference is given to using isocyanates from the series of the aliphatic or cycloaliphatic representatives, which have a carbon backbone (without the NCO groups present) of 3 to 30, preferably 4 to 20, carbon atoms.

Particularly preferred compounds of component (b) conform to the type specified above having aliphatically and/or cycloaliphatically attached NCO groups, such as, for example, bis(isocyanatoalkyl)ethers, bis- and tris(isocyanatoalkyl)benzenes, -toluenes, and -xylenes, propane diisoscyanates, butane diisocyanates, pentane diisocyanates, hexane diisocyanates (e.g. hexamethylene diisocyanate, HDI), heptane diisocyanates, octane diisocyanates, nonane diisocyanates (e.g. trimethyl-HDI (TMDI), generally as a mixture of the 2,4,4 and 2,2,4 isomers), nonane triisocyanates (e.g. 4-isocyanatomethyl-1,8-octane diisocyanate), decane diisocyanates, decane triisocyanates, undecane diisocyanates, undecane triisocyanates, dodecane diisocyanates, dodecane -triisocyanates, 1,3- and 1,4-bis(isocyanatomethyl)cyclohexanes (H₆XDI), 3-isocyanatomethyl-3,5,5-trimethylcyclohexyl isocyanate (isophorone diisocyanate, IPDI), bis(4-isocyanatocyclohexyl)methane (H₁₂MDI) or bis(isocyanatomethyl)norbornane (NBDI).

Very particularly preferred compounds of component (b) are hexamethylene diisocyanate (HDI), trimethyl-HDI (TMDI), 2-methylpentane 1,5-diisocyanate (MPDI), isophorone diisocyanate (IPDI), 1,3- and 1,4-bis(isocyanatomethyl)cyclohexane (H₆XDI), bis(isocyanatomethyl)norbornane (NBDI), 3(4)-isocyanatomethyl-1-methylcyclohexyl isocyanate (IMCI) and/or 4,4′-bis(isocyanatocyclohexyl)methane (H₁₂MDI) or mixtures of these isocyanates. Further examples are derivatives of the above diisocyanates with a uretdione, isocyanurate, urethane, allophanate, biuret, iminooxadiazinedione and/or oxadiazinetrione structure and with more than two NCO groups.

The amount of constituent (b) in the coating composition for use in accordance with the invention is preferably 1.0 to 4.0 mol, more preferably 1.2 to 3.8 mol, more particularly 1.5 to 3.5 mol, based in each case on the constituent (a) of the coating composition for use in accordance with the invention.

### (c) Polyoxyalkylene Ethers

The polyurethaneurea has units which originate from a copolymer comprising polyethylene oxide and poly-C₄-C₁₂-alkylene oxide. These copolymer units are present in the form of end groups in the poyurethaneurea.

Nonionically hydrophilicizing compounds (c) are, for example, monofunctional polyalkylene oxide polyether alcohols containing an average 5 to 70, preferably 7 to 55, ethylene oxide units per molecule, of the kind available in conventional manner through alkoxylation of suitable starter molecules (e.g. in Ullmanns Enzyklopädie der technischen Chemie, 4th Edition, Volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as diethylene glycol monobutyl ether, for example, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine, and also heterocyclic secondary amines such as morpholine, pyrrolidine, piperidine or 1H-pyrazole. Preferred starter molecules are saturated monoalcohols. Particular preference is given to using diethylene glycol monobutyl ether as a starter molecule.

The alkylene oxides, ethylene oxide and C₄-C₁₂-alkylene oxide, can be used in any order or else in a mixture in the alkoxylation reaction.

Polyalkylene oxide polyether alcohols are mixed polyalkylene oxide polyethers of ethylene oxide and C₄-C₁₂-alkylene oxide, whose alkylene oxide units are composed preferably to an extent of at least 30 mol %, more preferably at least 40 mol %, of ethylene oxide units. Preferred non-ionic compounds are monofunctional mixed polyalkylene oxide polyethers which contain at least 40 mol % of ethylene oxide units and not more than 60 mol % of C₄-C₁₂-alkylene oxide units.

The C₄-C₁₂-alkylene oxide unit describes epoxides (oxiranes) with alkyl substituent or alkyl substituents, it being possible for the number of carbon atoms to be from 4 to 12.

C₄-C₁₂-Alkylene oxide units contemplated are preferably those in which the oxirane unit is incorporated in 1,2-position. Examples are 1,2-epoxybutane (butylene oxide), 1,2-epoxypentane, 1,2-epoxyhexane, 1,2-epoxyoctane, 1,2-epoxydecane and 1,2-epoxydodecane. Preferred from the stated selection are 1,2-epoxybutane (butylene oxide), 1,2-epoxypentane and 1,2-epoxyhexane. Mixtures of these units are also contemplated. A particularly preferred C₄-C₁₂-alkylene oxide used is 1,2-epoxybutane (butylene oxide), and with very particular preference the C₄-C₁₂-alkylene oxide used is exclusively 1,2-epoxybutane.

The average molar weight of the polyoxyalkylene ether is preferably 500 g/mol to 5000 g/mol, more preferably 1000 g/mol to 4000 g/mol, more preferably 1000 to 3000 g/mol.

The amount of constituent (c) in the coating composition for use in accordance with the invention is preferably 0.01 to 0.5 mol, more preferably 0.02 to 0.4 mol, more particularly 0.04 to 0.3 mol, based in each case on constituent (a) of the coating composition for use in accordance with the invention.

In accordance with the invention it has been possible to show that the polyurethaneureas with end groups based on mixed polyoxyalkylene ethers comprising polyethylene oxide and poly-C₄-C₁₂-alkylene oxide are especially suitable for producing coatings having a high hydrophilicity. As will be shown later on below, in comparison to polyurethaneureas terminated only by polyethylene oxide, the coatings of the invention effect a significantly low contact angle and are therefore more hydrophilic in form.

### (d) Diamine or Amino Alcohol

The polyurethaneurea includes units which originate from at least one diamine or amino alcohol.

Use is made of what are known as chain extenders for the preparation of the coating composition. Such chain extenders are diamines or polyamines and also hydrazides, e.g. hydrazine, 1,2-ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine, adipic dihydrazide, 1,4-bis(aminomethyl)cyclohexane, 4,4′-diamino-3,3′-dimethyldicyclohexylmethane and other (C₁-C₄) di- and tetraalkyldicyclohexylmethanes, e.g. 4,4′-diamino-3,5-diethyl-3′,5′-diisopropyldicyclohexylmethane.

Suitable diamines or amino alcohols are generally low molecular weight diamines or amino alcohols which contain active hydrogen with differing reactivity towards NCO groups, such as compounds which as well as a primary amino group also contain secondary amino groups or which as well as amino group (primary or secondary) also contain OH groups. Examples of such compounds are primary and secondary amines, such as 3-amino-1-methylaminopropane, 3-amino-1-ethylaminopropane, 3-amino-1-cyclohexylaminopropane, 3-amino-1-methylaminobutane, and also amino alcohols, such as N-aminoethylethanolamine, ethanolamine, 3-aminopropanol, neopentanolamine and, with particular preference, diethanolamine.

The constituent (d) of the coating composition for use in accordance with the invention can be used, in the context of the preparation of the composition, as a chain extender and/or as a chain end.

The amount of constituent (d) in the coating composition for use in accordance with the invention is preferably 0.05 to 3.0 mol, more preferably 0.1 to 2.0 mol, more particularly 0.2 to 1.5 mol, based in each case on constituent (a) of the coating composition for use in accordance with the invention.

### (e) Polyols

In a further embodiment the polyurethaneurea comprises additional units which originate from at least one further polyol.

The further low molecular weight polyols (e) used to synthesize the polyurethaneureas have the effect, generally, of stiffening and/or branching the polymer chain. The molecular weight is preferably 62 to 500 g/mol, more preferably 62 to 400 g/mol, more particularly 62 to 200 g/mol.

Suitable polyols may contain aliphatic, alicyclic or aromatic groups. Mention may be made here, for example, of the low molecular weight polyols having up to about 20 carbon atoms per molecule, such as, for example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrated bisphenol A (2,2-bis(4-hydroxycyclohexyl)propane), and also trimethylolpropane, glycerol or pentaerythritol, and mixtures of these and, if desired, other low molecular weight polyols as well. Use may also be made of ester diols such as, for example, α-hydroxybutyl-ε-hydroxycaproic acid ester, ω-hydroxyhexyl-γ-hydroxybutyric acid ester, adipic acid (β-hydroxyethyl) ester or terephthalic acid bis(11-hydroxyethyl) ester.

The amount of constituent (e) in the coating composition for use in accordance with the invention is preferably 0.1 to 1.0 mol, more preferably 0.2 to 0.9 mol, more particularly 0.2 to 0.8 mol, based in each case on constituent (a) of the coating composition for use in accordance with the invention.

(f) Further Amine- and/or Hydroxy-Containing Units (Synthesis Component)

The reaction of the isocyanate-containing component (b) with the hydroxy- or amine-functional compounds (a), (c), (d) and, if used, (e) takes place typically with a slight NCO excess being observed over the reactive hydroxy or amine compounds. Dispersion in water hydrolyzes residues of isocyanate groups to give amine groups. However, in the individual case, it may be important to block the remaining residue of isocyanate groups prior to dispersing the polyurethaneurea.

The coating compositions provided in accordance with the invention may, therefore, also comprise synthesis components (f), which are located in each case at the chain ends and cap them. These units derive on the one hand from monofunctional compounds that are reactive with NCO groups, such as monoamines, more particularly mono-secondary amines, or monoalcohols.

Mention may be made here, for example, of ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine and suitable substituted derivatives thereof.

Since the units (f) are used essentially in the coating compositions of the invention to destroy the NCO excess, the amount required is dependant essentially on the amount of the NCO excess, and cannot be specified generally.

In one preferred embodiment of the present invention no component (f) is used, so that polyurethaneurea comprises only the constituents (a) to (d) and, if desired, component (e). It is further preferred if the polyurethaneurea is composed of constituents (a) to (d) and, if desired, of component (e), in other words not comprising any further synthesis components.

### (g) Further Constituents

Furthermore, the coating composition may comprise further constituents such as additives and fillers typical for the intended purpose. An example of such are active pharmacological substances and additives which promote the release of active pharmacological substances (drug-eluting additives), and medicaments.

Medicaments which may be used in the coatings of the invention on the medical devices are generally, for example, thromboresistant agents, antibiotic agents, antitumour agents, growth hormones, antiviral agents, antiangiogenic agents, angiogenic agents, antimitotic agents, anti-inflammatory agents, cell cycle regulators, genetic agents, hormones, and also their homologues, derivatives, fragments, pharmaceutical salts, and combinations thereof.

Specific examples of such medicaments hence include thromboresistant (non-thrombogenic) agents and other agents for suppressing acute thrombosis, stenosis or late restenosis of the arteries, examples being heparin, streptokinase, urokinase, tissue plasminogen activator, anti-thromboxan-B₂ agent; anti-B-thromboglobulin, prostaglandin-E, aspirin, dipyridimol, anti-thromboxan-A₂ agent, murine monoclonal antibody 7E3, triazolopyrimidine, ciprostene, hirudin, ticlopidine, nicorandil, etc. A growth factor can likewise be utilized as a medicament in order to suppress subintimal fibromuscular hyperplasia at the arterial stenosis site, or any other cell growth inhibitor can be utilized at the stenosis site.

The medicament may also be composed of a vasodilator, in order to counteract vasospasm—for example, an antispasm agent such as papaverine. The medicament may be a vasoactive agent per se, such as calcium antagonists, or α- and β-adrenergic agonists or antagonists. In addition the therapeutic agent may be a biological adhesive such as cyanoacrylate in medical grade, or fibrin, which is used, for example, for bonding a tissue valve to the wall of a coronary artery.

The therapeutic agent may further be an antineoplastic agent such as 5-fluorouracil, preferably with a controlling releasing vehicle for the agent (for example, for the use of an ongoing controlled releasing antineoplastic agent at a tumour site).

The therapeutic agent may be an antibiotic, preferably in combination with a controlling releasing vehicle for the ongoing release from the coating of a medical device at a localized focus of infection within the body. Similarly, the therapeutic agent may comprise steroids for the purpose of suppressing inflammation in localized tissue, or for other reasons.

Specific examples of suitable medicaments include:
(a) heparin, heparin sulphate, hirudin, hyaluroic acid, chondroitin sulphate, dermatan sulphate, keratan sulphate, lytic agents, including urokinase and streptokinase, their homologues, analogues, fragments, derivatives and pharmaceutical salts thereof;
(b) antibiotic agents such as penicillins, cephalosporins, vacomycins, aminoglycosides, quinolones, polymyxins, erythromycins; tetracyclines, chloramphenicols, clindamycins, lincomycins, sulphonamides, their homologues, analogues, derivatives, pharmaceutical salts and mixtures thereof;
(c) paclitaxel, docetaxel, immunosuppressants such as sirolimus or everolimus, alkylating agents, including mechlorethamine, chlorambucil, cyclophosphamide, melphalane and ifosfamide; antimetabolites, including methotrexate, 6-mercaptopurine, 5-fluorouracil and cytarabine; plant alkaloids, including vinblastin; vincristin and etoposide; antibiotics, including doxorubicin, daunomycin, bleomycin and mitomycin; nitrosurea, including carmustine and lomustine; inorganic ions, including cisplatin; biological reaction modifiers, including interferon; angiostatins and endostatins; enzymes, including asparaginase; and hormones, including tamoxifen and flutamide, their homologues, analogues, fragments, derivatives, pharmaceutical salts and mixtures thereof; and
(d) antiviral agents such as amantadine, rimantadine, rabavirin, idoxuridine, vidarabin, trifluridine, aciclovir, ganciclovir, zidovudine, phosphonoformates, interferons, their homologues, analogues, fragments, derivatives, pharmaceutical salts and mixtures thereof; and
e) antiinflammatory agents such as, for example, ibuprofen, dexamethasone or methylprednisolone.

In one preferred embodiment the coating composition provided in accordance with the invention comprises a polyurethaneurea which is synthesized from
a) at least one polycarbonate polyol;
b) at least one polyisocyanate;
c) at least one monofunctional mixed polyoxyalkylene ether of polyethylene oxide and poly-C₄-C₁₂-alkylene oxide; and
d) at least one diamine or amino alcohol.

In a further embodiment of the present invention the coating composition provided in accordance with the invention comprises a polyurethaneurea which is synthesized from
a) at least one polycarbonate polyol;
b) at least one polyisocyanate;
c) at least one monofunctional mixed polyoxyalkylene ether of polyethylene oxide and poly-C₄-C₁₂-alkylene oxide;
d) at least one diamine or amino alcohol; and
e) at least one polyol.

In a further embodiment of the present invention the coating composition provided in accordance with the invention comprises a polyurethaneurea which is synthesized from
a) at least one polycarbonate polyol;
b) at least one polyisocyanate;
c) at least one monofunctional mixed polyoxyalkylene ether of polyethylene oxide and poly-C₄-C₁₂-alkylene oxide;
d) at least one diamine or amino alcohol;
e) at least one polyol; and
f) at least one further amine- or hydroxy-containing monomer which is located on the polymer chain ends.

As already mentioned, in a very particularly preferred embodiment of the present invention, the polyurethaneurea consists only of the constituents (a) to (d) and, if used, (e).

Preference is also given in accordance with the invention to polyurethaneureas which are synthesized from
a) at least one polycarbonate polyol having an average molar weight between 400 g/mol and 6000 g/mol and a hydroxyl functionality of 1.7 to 2.3, or mixtures of such polycarbonate polyols;
b) at least one aliphatic, cycloaliphatic or aromatic polyisocyanate or mixtures of such polyisocyanates in an amount per mole of the polycarbonate polyol of 1.0 to 4.0 mol;
c) at least one monofunctional mixed polyoxyalkylene ether of polyethylene oxide and poly-C₄-C₁₂-alkylene oxide or a mixture of such polyethers, having an average molar weight between 500 g/mol and 5000 g/mol, in an amount per mole of the polycarbonate polyol of 0.01 to 0.5 mol;
d) at least one aliphatic or cycloaliphatic diamine or at least one amino alcohol, as so-called chain extenders, or mixtures of such compounds in an amount per mole of the polycarbonate polyol of 0.05 to 3.0 mol;
e) if desired, one or more short-chain aliphatic polyols having a molar weight between 62 g/mol and 500 g/mol, in an amount per mole of the polycarbonate polyol of 0.1 to 1.0 mol; and
f) if desired, amine- or OH-containing units which are located on, and cap, the polymer chain ends.

Preference is further given in accordance with the invention to polyurethaneureas which are synthesized from
a) at least one polycarbonate polyol having an average molar weight between 500 g/mol and 5000 g/mol and a hydroxyl functionality of 1.8 to 2.2, or mixtures of such polycarbonate polyols;
b) at least one aliphatic, cycloaliphatic or aromatic polyisocyanate or mixtures of such polyisocyanates in an amount per mole of the polycarbonate polyol of 1.2 to 3.8 mol;
c) at least one monofunctional mixed polyoxyalkylene ether of polyethylene oxide and poly-C₄-C₁₂-alkylene oxide or a mixture of such polyethers, having an average molar weight between 1000 g/mol and 4000 g/mol, in an amount per mole of the polycarbonate polyol of 0.02 to 0.4 mol;
d) at least one aliphatic or cycloaliphatic diamine or at least one amino alcohol, as so-called chain extenders, or mixtures of such compounds in an amount per mole of the polycarbonate polyol of 0.1 to 2.0 mol;
e) if desired, one or more short-chain aliphatic polyols having a molar weight between 62 g/mol and 400 g/mol, in an amount per mole of the polycarbonate polyol of 0.2 to 0.9 mol; and
f) if desired, amine- or OH-containing units which are located on, and cap, the polymer chain ends.

Preference is also further given in accordance with the invention to polyurethaneureas which are synthesized from
a) at least one polycarbonate polyol having an average molar weight between 600 g/mol and 3000 g/mol and a hydroxyl functionality of 1.9 to 2.1, or mixtures of such polycarbonate polyols;
b) at least one aliphatic, cycloaliphatic or aromatic polyisocyanate or mixtures of such polyisocyanates in an amount per mole of the polycarbonate polyol of 1.5 to 3.5 mol;
c) at least one monofunctional mixed polyoxyalkylene ether of polyethylene oxide and poly-C₄-C₁₂-alkylene oxide or a mixture of such polyethers, having an average molar weight between 1000 g/mol and 3000 g/mol, in an amount per mole of the polycarbonate polyol of 0.04 to 0.3 mol;
d) at least one aliphatic or cycloaliphatic diamine or at least one amino alcohol, as so-called chain extenders, or mixtures of such compounds in an amount per mole of the polycarbonate polyol of 0.2 to 1.5 mol; and
e) if desired, one or more short-chain aliphatic polyols having a molar weight between 62 g/mol and 200 g/mol, in an amount per mole of the polycarbonate polyol of 0.2 to 0.8 mol; and
f) if desired, amine- or OH-containing units which are located on, and cap, the polymer chain ends.
The coating composition may be applied to a medical device.

### Use of the Inventive Coating Composition in the Form of a Dispersion

The coating composition of the invention in the form of a dispersion can be used to form a coating on a medical device.

The term “medical device” is to be understood broadly in the context of the present invention. Suitable, non-limiting examples of medical devices (including instruments) are contact lenses; cannulas; catheters, for example urology catheters such as urinary catheters or ureteral catheters; central venous catheters; venous catheters or inlet or outlet catheters; dilation balloons; catheters for angioplasty and biopsy; catheters used for introducing a stent, an embolism filter or a vena caval filter; balloon catheters or other expandable medical devices; endoscopes; laryngoscopes; tracheal devices such as endotracheal tubes, respirators and other tracheal aspiration devices; bronchoalveolar lavage catheters; catheters used in coronary angioplasty; guide rods, insertion guides and the like; vascular plugs; pacemaker components; cochlear implants; dental implant tubes for feeding, drainage tubes; and guide wires.

The coating composition of the invention may be used, furthermore, for producing protective coatings, for example for gloves, stents and other implants; external (extracorporeal) blood lines (blood-carrying pipes); membranes, for example for dialysis; blood filters; devices for circulatory support; dressing material for wound management; urine bags and stoma bags. Also included are implants which comprise a medically active agent, such as medically active agents for stents or for balloon surfaces or for contraceptives.

Typically the medical device is formed from catheters, endoscopes, laryngoscopes, endotracheal tubes, feeding tubes, guide rods, stents, and other implants.

There are many materials suitable as a substrate of the surface to be coated, such as metals, textiles, ceramics or plastics, the use of plastics being preferred for the production of medical devices.

In accordance with the invention it has been found that it is possible to produce medical devices having very hydrophilic and hence lubricous, blood-compatible surfaces by using the coating compositions of the type described above to coat the medical devices. The coating compositions described above are obtained preferably as aqueous dispersions and are applied to the surface of the medical devices.

### Preparation of the Coating Compositions

The constituents of the coatings, described in more detail above, are generally reacted such that first of all an isocyanate-functional prepolymer free of urea groups is prepared by reaction of the constituents (a), (b), (c) and, if desired, (e), the amount-of-substance ratio of isocyanate groups to isocyanate-reactive groups of the polycarbonate polyol being preferably 0.8 to 4.0, more preferably 0.9 to 3.8, more particularly 1.0 to 3.5.

In an alternative embodiment it is also possible first to react the constituent (a) separately with the isocyanate (b). Then, after that, the constituents (c) and (e) can be added and reacted. Subsequently, in general, the remaining isocyanate groups are given an amino-functional chain extension or termination, before, during or after dispersion in water, the ratio of equivalents of isocyanate-reactive groups of the compounds used for chain extension to free isocyanate groups of the prepolymer being preferably between 40% to 150%, more preferably between 50% to 120%, more particularly between 60% to 120% (constituent d)).

The polyurethaneurea dispersions are prepared preferably by the process known as the acetone process. For the preparation of the polyurethaneurea dispersion by this acetone process, some or all of the constituents (a), (c) and (e), which must not contain any primary or secondary amino groups, and the polyisocyanate component (b) are typically introduced, for the preparation of an isocyanate-functional polyurethane prepolymer, and where appropriate are diluted with a water-miscible solvent which is nevertheless inert towards isocyanate groups, and the batch is heated to temperatures in the range from 50 to 120° C. To accelerate the isocyanate addition reaction it is possible to use the catalysts known in polyurethane chemistry, an example being dibutyltin dilaurate. Preference is given to synthesis without catalyst.

Suitable solvents are the typical aliphatic, keto-functional solvents such as, for example, acetone, butanone, which can be added not only at the beginning of the preparation but also, if desired, in portions later on as well. Acetone and butanone are preferred. Other solvents such as xylene, toluene, cyclohexane, butyl acetate, methoxypropyl acetate and solvents with ether units or ester units, for example, may likewise be used and may be removed in whole or in part by distillation or may remain entirely in the dispersion.

Subsequently any constituents of (c) and (e) not added at the beginning of the reaction are metered in.

In a preferred way, the prepolymer is prepared without addition of solvent and only for its chain extension is diluted with a suitable solvent, preferably acetone.

In the preparation of the polyurethane prepolymer, the amount-of-substance ratio of isocyanate groups to isocyanate-reactive groups is preferably 0.8 to 4.0, more preferably 0.9 to 3.8, more particularly 1.0 to 3.5.

The reaction to give the prepolymer takes place partially or completely, but preferably completely. In this way, polyurethane prepolymers which contain free isocyanate groups are obtained, in bulk or in solution.

Subsequently, in a further process step, if it has not yet taken place or has taken place only partly, the resulting prepolymer is dissolved by means of aliphatic ketones such as acetone or butanone.

Subsequently, possible NH₂—, NH-functional and/or OH-functional components are reacted with the remaining isocyanate groups. This chain extension/termination may be carried out alternatively in solvent prior to dispersing, during dispersing, or in water after dispersion has taken place. Preference is given to carrying out the chain extension prior to dispersing in water.

Where compounds conforming to the definition of (d) with NH₂ or NH groups are used for chain extension, the chain extension of the prepolymers takes place preferably prior to the dispersing.

The degree of chain extension, in other words the ratio of equivalents of NCO-reactive groups of the compounds used for chain extension to free NCO groups of the prepolymer, is preferably between 40% to 150%, more preferably between 50% to 120%, more particularly between 60% to 120%.

The aminic components (d) may if desired be used in water-diluted or solvent-diluted form in the process of the invention, individually or in mixtures, in which case any sequence of addition is possible in principle.

If water or organic solvents are used as diluents, the diluent content is preferably 70% to 95% by weight.

The preparation of the polyurethaneurea dispersion from the prepolymers takes place following the chain extension. For this purpose, either the dissolved and chain-extended polyurethaneurea polymer is introduced into the dispersing water, where appropriate with strong shearing, such as vigorous stirring, for example, or, conversely, the dispersing water is stirred into the prepolymer solutions. Preferably the water is added to the dissolved prepolymer.

The solvent still present in the dispersions after the dispersing step is typically then removed by distillation. Its removal during the actual dispersing is likewise a possibility.

The solids content of the polyurethaneurea dispersion after the synthesis is between 20% to 70% by weight, preferably 20% to 65% by weight. For coating experiments these dispersions can be diluted arbitrarily with water, in order to allow the thickness of the coating to be varied. All concentrations from 1% to 60% by weight are possible; preference is given to concentrations in the 1% to 40% by weight range.

In this context it is possible to attain any desired coat thicknesses, such as, for example from a few 100 nm up to several 100 μm, although higher and lower thicknesses are possible in the context of the present invention.

The coating compositions for the coating of the medical devices can be diluted to any desired value by dilution of the aqueous dispersions with water. Furthermore, it is possible to add thickeners, in order, where appropriate, to allow the viscosity of the coating compositions to be increased.

Further additions, such as antioxidants, buffering agents for adjusting the pH or pigments, for example, are likewise possible. It is also possible if desired, furthermore, to use further additions such as hand assistants, dyes, matting agents, UV stabilizers, light stabilizers, hydrophobicizing agents, hydrophilic agents and/or flow control assistants.

Starting from these dispersions, then, medical coatings are produced by the processes described above.

In accordance with the invention it has emerged that the resulting coatings on medical devices differ according to whether the coating is produced starting from a dispersion or from a solution.

The coatings of the invention on medical devices have advantages when they are obtained starting from dispersions of the above-described coating compositions, since dispersions of the coating systems of the invention lead to coatings on the medical devices that do not contain any organic solvent residues, and therefore are generally unobjectionable from a toxicity standpoint, and at the same time lead to a more pronounced hydrophilicity, which is evident, for example, from a small contact angle. Reference is made on this point to the experiments, and comparative experiments, that are elucidated later on below.

The medical devices can be coated in this case with the coating compositions of the invention by a variety of methods. Examples of suitable coating techniques for this purpose include knifecoating, printing, transfer coating, spraying, spin coating or dipping.

A wide variety of substrates can be coated, such as metals, textiles, ceramics and plastics. Preference is given to coating medical devices manufactured from metals or from plastic. Examples of metals include the following: medical stainless steel or nickel titanium alloys. Many polymer materials are conceivable from which the medical device may be constructed, examples being polyamide; polystyrene; polycarbonate; polyethers; polyesters; polyvinyl acetate; natural and synthetic rubbers; block copolymers of styrene and unsaturated compounds such as ethylene, butylene and isoprene; polyethylene or copolymers of polyethylene and polypropylene; silicone; polyvinyl chloride (PVC) and polyurethanes. For better adhesion of the hydrophilic polyurethaneureas to the medical device, further suitable coatings may be applied as a base before these hydrophilic coating materials are applied.

The aqueous polyurethane dispersions which are used as starting material for producing the coatings can be prepared by any desired processes, although the above-described acetone process is preferred.

In addition to the hydrophilic properties of the improvement of slip, the coating compositions provided in accordance with the invention are also distinguished by a high level of blood compatibility. As a result, working with these coatings is also advantageous, particularly in blood contact. In comparison to polymers of the prior art, the materials exhibit reduced coagulation tendency in blood contact.

Besides the stated applications in the medical sector, the systems of the invention can also be used for coating technical substrates in the non-medical sector, for producing easy-to-clean or self-cleaning surfaces, for coating glazing systems and optical glasses and lenses, for coating substrates in the hygiene sector, for coating packaging materials, for reducing the growth on the coated surfaces, for coating above-water and underwater substrates for reducing the substrates' frictional resistance toward water, for preparing substrates for printing, for preparing formulations for cosmetic applications or for producing active-ingredient-releasing systems for the coating of seeds.

Advantageous properties of catheters provided with a hydrophilic polyurethaneurea coating using the coating composition of the invention are illustrated below in the examples.

### EXAMPLES

The NCO content of the resins described in the examples was determined by titration in accordance with DIN EN ISO 11909.

The solids contents were determined in accordance with DIN-EN ISO 3251.1 g of polyurethaneurea dispersion was dried at 115° C. to constant weight (15-20 min) using an infrared dryer.

The average particle sizes of the polyurethaneurea dispersions are measured using the High Performance Particle Sizer (HPPS 3.3) from Malvern Instruments.

Unless noted otherwise, amounts indicated in % are % by weight and relate to the aqueous dispersion obtained.

### Substances and Abbreviations Used:

Desmophen C2200: Polycarbonate polyol, OH number 56 mg KOH/g, number-average molecular weight 2000 g/mol (Bayer, MaterialScience AG, Leverkusen, DE)

### Example 1

This example describes the preparation of an inventive coating composition in the form of a polyurethaneurea dispersion.

277.2 g of Desmophen C 2200, 33.6 g of monofunctional polyether based on ethylene oxide/butylene oxide (number-average molecular weight 2250 g/mol, OH number 25 mg KOH/g, fraction of butylene oxide (=1,2-epoxybutane): 25% by weight) and 6.7 g of neopentyl glycol were introduced at 65° C. and homogenized by stirring for 5 minutes. At 65° C., this mixture was admixed over the course of 1 minute first with 71.3 g of 4,4′-bis(isocyanatocyclohexyl)methane (H₁₂MDI) and then with 11.9 g of isophorone diisocyanate. This mixture was heated to 120° C. After 8 h the theoretical NCO value was reached. The completed prepolymer was dissolved at 50° C. in 711 g of acetone and then at 40° C. a solution of 4.8 g of ethylene diamine in 16 g of water was metered in over the course of 10 min. The subsequent stirring time was 15 min. Subsequently, over the course of 15 min, dispersion was carried out by addition of 590 g of water. After that the solvent was removed by distillation under reduced pressure. This gave a polyurethaneurea dispersion having a solids content of 39.0% and an average particle size of 522 nm.

### Example 2

### Production of the Coatings and Measurement of the Static Contact Angle

The coatings for the measurement of the static contact angle were produced on purified glass plates using a knife coater (knife coater gap: 210 micrometers). This gave a homogeneous coating, which was dried at 100° C. for 2 h or alternatively only at 23° C. The coated glass plates obtained were subjected directly to a contact angle measurement.

A static contact angle measurement was performed on the resulting coatings on the glass plates. Using the video contact angle measuring instrument OCA20 from Dataphysics, with computer-controlled injection, 10 drops of Millipore water were placed on the specimen, and their static wetting angle was measured. Beforehand, using an antistatic dryer, the static charge (if present) on the sample surface was removed.

TABLE 1
Static contact angle measurements

| PU FILM made from | Contact angle [°] |
|---|---|
| Inventive Example 1 (drying 100° C.) | 34.1 |
| Inventive Example 1 (drying 23° C.) | 23.2 |

As Table 1 shows, the polycarbonate-containing coating of Inventive Example 1 gives an extremely hydrophilic coating with a static contact angle≦40°.

1.-10. (canceled)

11. A coating composition in the form of a dispersion, which comprises a polyurethaneurea which
(1) is terminated with a copolymer unit comprising polyethylene oxide and poly-C₄-C₁₂-alkylene oxide, and
(2) further comprises at least one hydroxyl-group-containing polycarbonate polyol.

12. The coating composition according to claim 11, wherein the polyurethaneurea comprises units which originate from at least one aliphatic, cycloaliphatic or aromatic isocyanate.

13. The coating composition according to claim 11, wherein the polyurethaneurea has a maximum ionic modification of 2.5% by weight.

14. The coating composition according to claim 11, wherein the polyurethaneurea is synthesized from components comprising:
a) at least one polycarbonate polyol having an average molar weight of from 400 to 6000 g/mol and a hydroxyl functionality of 1.7 to 2.3, or mixtures of such polycarbonate polyols;
b) at least one aliphatic, cycloaliphatic or aromatic polyisocyanate or mixtures of such polyisocyanates in an amount per mole of the polycarbonate polyol of 1.0 to 4.0 mol;
c) at least one monofunctional mixed polyoxyalkylene ether of polyethylene oxide and poly-C₄-C₁₂-alkylene oxide or a mixture of such polyethers, having an average molar weight of from 500 to 5000 g/mol, in an amount per mole of the polycarbonate polyol of 0.01 to 0.5 mol;
d) at least one aliphatic or cycloaliphatic diamine or at least one amino alcohol, as so-called chain extenders, or mixtures of such compounds in an amount per mole of the polycarbonate polyol of 0.05 to 3.0 mol;
e) optionally, one or more short-chain aliphatic polyols having a molar weight of from 62 to 500 g/mol, in an amount per mole of the polycarbonate polyol of 0.1 to 1.0 mol; and
optionally, amine- or OH-containing units which are located on, and cap, the polymer chain ends.

15. A process for preparing the coating composition according to claim 14, comprising the following process steps:
(I) initially introducing the components (a), (b), (c) and, if desired, (e) and, optionally diluting the initially introduced constituents with a water-miscible solvent which is inert towards isocyanate groups;
(II) heating the composition obtained from (I) to temperatures in the range of from 50 to 120° C.;
(III) metering in any components of (c) and (e) not added at the beginning of the reaction;
(IV) dissolving the resulting prepolymer by means of aliphatic ketones;
(V) adding component (d) for chain extension;
(VI) adding water for dispersing; and
(VII) removing the aliphatic ketone,

16. The process according to claim 15, wherein the aliphatic ketone is removed by distillation.

17. A coating composition in the form of a dispersion, obtained according to the process of claim 15.

18. A coating on a substrate, obtained by applying the coating composition according to claim 11 to a substrate and drying the coated substrate.

19. The coating according to claim 18, wherein the substrate is a medical device.

20. A medical device comprising the coating composition according to claim 11 which is dried.

21. The coating composition according to claim 11, wherein the coating composition is for coating technical substrates in the non-medical sector, for producing easy-to-clean or self-cleaning surfaces, for coating glazing systems and optical glasses and lenses, for coating substrates in the hygiene sector, for coating packaging materials, for reducing growth on the coated surfaces, for the coating of above-water and underwater substrates in order to reduce the substrates' frictional resistance toward water, for preparing substrates for printing, for producing formulations for cosmetic applications or for producing active-ingredient-releasing systems for the coating of seeds.
